(19) United States
(12) Patent Application Publication
(10) Pub. No.: US 2021/0304525 A1
(43) Pub. Date: Sep. 30, 2021

(54) INFORMATION PROVIDING DEVICE, INFORMATION PROVIDING SYSTEM, AND INFORMATION PROVIDING METHOD

(71) Applicant: HONDA MOTOR CO., LTD., Tokyo (JP)

(72) Inventor: Akira Terauchi, Wako-shi (JP)

(21) Appl. No.: 17/197,592

(22) Filed: Mar. 10, 2021

(30) Foreign Application Priority Data
Mar. 31, 2020 (JP) 2020-063665

(51) Int. Cl. G07C 5/00; G06Q 10/08

(52) U.S. Cl. CPC G07C 5/008; H04L 67/12; G06Q 10/0833

(57) ABSTRACT

An information providing device includes a communication control unit for communicating with a server, an implementation information acquisition unit for acquiring implementation information indicating implementation status of a service which is provided at a stop position of a movable body by the communication control unit, a moving state detection unit for detecting a moving state of the movable body, and a notification unit for notifying the implementation status of the service based on the implementation information when the moving state detection unit detects a specific state from which it is presumed that the movable body will start moving.

INCORPORATION BY REFERENCE

The present application claims priority under 35 U.S.C. § 119 to Japanese Patent Application No. 2020-063665 filed on Mar. 31, 2020. The content of the application is incorporated herein by reference in its entirety.

### BACKGROUND OF THE INVENTION

### Field of the Invention

The present invention relates to an information providing device, an information providing system, and an information providing method.

### Description of the Related Art

Conventionally, various proposals to provide service for movable bodies such as vehicles have been made. For example, when a delivery service that specifies a vehicle as a delivery destination for a package is implemented, there has been proposed a technique for predicting a possibility that the vehicle, which is the delivery destination, will suddenly move and determining a procedure relating to delivery work (for example, see Japanese Patent Laid-Open No. 2019-101455).

As described in Japanese Patent Laid-Open No. 2019-101455, when a movable body which is a target of the service moves, it is desirable to cope with implementation of the service. However, in a state where a user who receives the service does not know implementation status of the service, there may be difficulty in taking an appropriate action.

The present invention has been made in view of such background, and an objective is to inform users of a service provided to movable bodies of implementation status of the service at appropriate timing.

### SUMMARY OF THE INVENTION

As a first aspect for achieving the above objective, there is mentioned an information providing device comprising a processor, wherein the processor functions as: a communication control unit for communicating with a server; an implementation information acquisition unit for acquiring, by the communication control unit, implementation information indicating implementation status of a service which is provided at a stop position of a movable body; a moving state detection unit for detecting a moving state of the movable body; and a notification control unit for notifying the implementation status of the service based on the implementation information when the moving state detection unit detects a specific state from which it is presumed that the movable body will start moving.

In the information providing device, the configuration may be that the processor functions as: a service determination unit for determining whether implementation of the service is completed based on the implementation information; and a request processing unit for causing the communication control unit to transmit request information requesting suspension or cancellation of the implementation of the service when the service determination unit determines that the implementation of the service is not completed, wherein the processor causes the request information to be transmitted, by a function of the request processing unit, in any of a period from the detection of the specific state to the start of moving of the movable body, when the movable body starts moving, and within a predetermined time after the movable body starts moving.

In the information providing device, the configuration may be that the processor notifies, by a function of the notification control unit, that the implementation of the service is suspended or cancelled when the service determination unit determines that the implementation of the service is not completed.

In the information providing device, the configuration may be that the processor, by a function of the request processing unit, causes the communication control unit to transmit first request information requesting suspension of the implementation of the service when the moving state detection unit detects start of moving of the movable body, and causes the communication control unit to transmit second request information requesting cancellation of the implementation of the service when a specific condition is satisfied after the movable body starts moving.

In the information providing device, the configuration may be that the processor functions as a setting unit for setting whether to transmit either first request information requesting suspension of the implementation of the service or second request information requesting cancellation of the implementation of the service, by the communication control unit, wherein: the processor causes the communication control unit to transmit request information requesting suspension or cancellation of the implementation of the service according to setting of the setting unit by a function of the request processing unit when the service determination unit determines that the implementation of the service is not completed; and the notification control unit notifies the service for which suspension is requested when the moving state detection unit detects stop of the movable body after request information requesting suspension of the implementation of the service is transmitted by the communication control unit.

As a second aspect for achieving the above objective, there is mentioned an information providing system comprising a server and an information providing device for communicating with the server, wherein the information providing device includes a processor, wherein the processor functions as: a communication control unit for communicating with the server; an implementation information acquisition unit for acquiring, by the communication control unit, implementation information indicating implementation status of a service which is provided at a stop position of a movable body; a moving state detection unit for detecting a moving state of the movable body; and a notification control unit for notifying the implementation status of the service based on the implementation information when the moving state detection unit detects a specific state from which it is presumed that the movable body will start moving, wherein the server transmits the implementation information indicating the implementation status of the service to the information providing device.

As a third aspect for achieving the above objective, there is mentioned a control method of an information providing device executed by a processor of the information providing device that provides information on implementation of a service, the control method of the information providing device comprising: acquiring implementation information indicating implementation status of the service whose service provision location is a stop position of a movable body from a server; detecting a moving state of the movable body; and notifying the implementation status of the service based on the implementation information when a specific state from which it is presumed that the movable body will start moving is detected.

### Advantageous Effect of Invention

According to the above configurations, the user enjoying the service is notified of the implementation status of the service when it is presumed that the movable body will start moving. This makes it possible to notify the implementation status of the service to the user of the service at appropriate timing, and the user can appropriately determine, for example, whether to enjoy the service or whether to move the movable body.

### BRIEF DESCRIPTION OF THE DRAWINGS

FIG. 1 is an explanatory diagram illustrating an outline of an information providing system;

FIG. 2 is a configuration diagram of a vehicle equipped with an information providing device;

FIG. 3 is a configuration diagram of the information providing device;

FIG. 4 is a sequence diagram illustrating an outline of operation of the information providing system;

FIG. 5 is a flowchart illustrating operation of the information providing device;

FIG. 6 is a flowchart illustrating operation of the information providing device;

FIG. 7 is a flowchart illustrating operation of the information providing device;

FIG. 8 is a flowchart illustrating operation of the information providing device;

FIG. 9 is a flowchart illustrating operation of the information providing device;

FIG. 10 is a flowchart illustrating operation of the information providing device;

FIG. 11 is a diagram illustrating an example of a purchase screen;

FIG. 12 is a diagram illustrating an example of a suspension notification screen; and

FIG. 13 is a diagram illustrating an example of an incompletion notification screen.

### DETAILED DESCRIPTION OF THE PREFERRED EMBODIMENTS

### [1. Outline of Information Providing System]

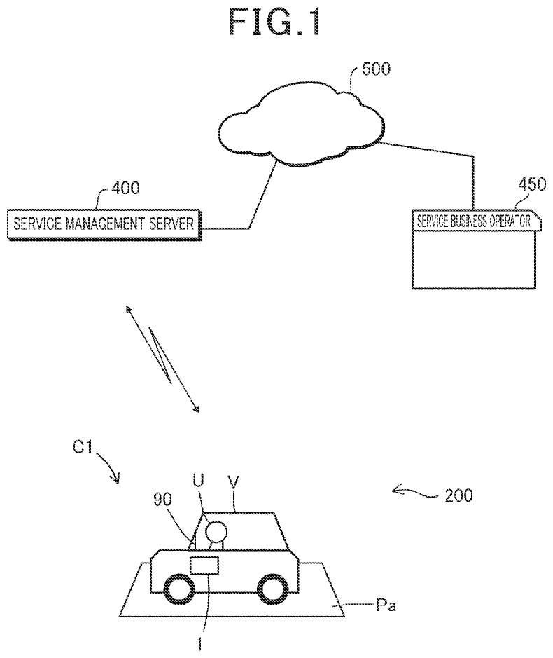

An outline of an information providing system 200 of an embodiment will be described with reference to FIG. 1.

The information providing system 200 is a system in which an information providing device 1 mounted on a vehicle V communicates with a service management server 400 via a communication network 500, and provides a user U on board the vehicle V with information on a service provided while the vehicle V is parked. The vehicle V corresponds to a movable body of the present invention.

The service management server 400 is a computer composed of a central processing unit (CPU, corresponding to the server processor according to the present invention), memory, communication unit, etc. (not shown).

As shown in C1 of FIG. 1, the service which the user U can enjoy is a service provided at a parking point Pa while the vehicle V is stopping, more specifically, while the vehicle V stays at the parking point Pa. This type of service includes services such as delivery of products to the vehicle V parked at the parking point Pa as a delivery location, processing and working for the vehicle V such as car washing, coating, and repair, and charging the vehicle V when the vehicle V is an electric vehicle or a hybrid vehicle (HEV). For example, there may be mentioned a fuel supply service in which a vehicle loaded with fuel of the vehicle V such as gasoline goes to the parking point Pa and supplies fuel in a fuel tank of the vehicle V parked at the parking point Pa.

FIG. 1 shows a service business operator 450 as a business operator who provides the vehicle V with a service. A computer (not shown) installed at a store or an office of the service business operator 450 or a portable terminal device (not shown) carried by a worker of the service business operator 450 can communicate with the service management server 400 through the communication network 500.

The service provided for the user U in the system of FIG. 1 may be free of charge, but in the embodiment, a paid service is assumed as an example, and paying a price and enjoying the service by the user U is called purchase. The information providing device 1 makes a service purchase request according to an operation of the user U. The service management server 400 receives the service purchase request, and notifies the service business operator 450 that the service is purchased. In response to the notification, the worker of the service business operator 450 goes to the parking point Pa and provides the service.

The information providing device 1 inquires of the service management server 400 status of provision of the service by the service business operator 450. For example, the service business operator 450 may provide the service, for example, while the user U is away from the vehicle V in a state where the vehicle V is parked at the parking point Pa. In this way, when the user U does not witness the provision of the service, the user U may not be able to determine whether the provision of the service has been completed or not. Therefore, the information providing device 1 can inquire of the service management server 400 the status of the provision of the service. The service management server 400 transmits implementation information indicating implementation status of the service to the information providing device 1 in response to the request from the information providing device 1.

### [2. Configuration of Vehicle]

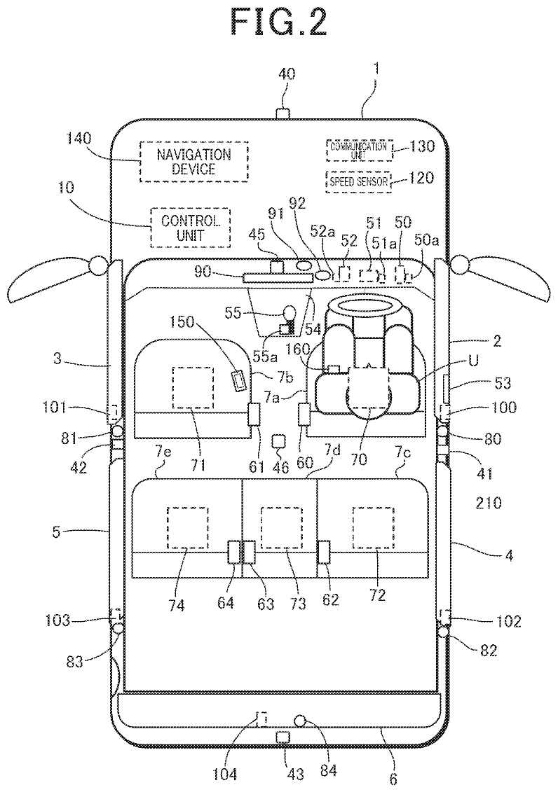

A configuration of the vehicle V equipped with the information providing device 1 will be described with reference to FIG. 2. The vehicle V is a passenger car with a seating capacity of five people, and has a driver's seat 7a, a passenger seat 7b, a rear right seat 7c, a rear center seat 7d, and a rear left seat 7e. The seats 7a-7e are provided with seatbelt switches 60-64 for detecting whether seatbelts (not shown) are fastened, and seating sensors 70-74, respectively.

FIG. 2 shows a situation where the user U holding a portable key 160 of the vehicle V is seated in the driver's seat 7a. In addition, a user terminal 150 used by the user U is placed on the passenger seat 7b. The vehicle V has a right front door 2, a left front door 3, a right rear door 4, and a left rear door 5, and a door knob of the right front door 2 is provided with a door touch sensor 53. The user U holding the portable key 160 can unlock the doors 2-6 of the vehicle V by touching the door touch sensor 53.

A front camera 40 for photographing forward of the vehicle V is provided at a front potion of the vehicle V, and a rear camera 43 for photographing rearward of the vehicle V is provided at a rear portion of the vehicle V. A right-side camera 41 for photographing a right-side direction of the vehicle V is provided at a right-side portion of the vehicle V, and a left-side camera 42 for photographing a left-side direction of the vehicle V is provided at a left-side portion of the vehicle V.

A dashboard of a vehicle interior is provided with a front seat camera 45 for photographing users seated in the driver's seat 7a and passenger seat 7b, a touch panel 90, a speaker 91, and a microphone 92. A ceiling of the vehicle interior is provided with a rear seat camera 46 for photographing users seated in the rear right seat 7c, rear center seat 7d, and rear left seat 7e.

The touch panel 90 has a configuration in which a display screen and a touch sensor for detecting a touch operation are overlapped, displays various screens according to control of a control unit 10 described later, and receives the touch operation by the user U.

The microphone 92 collects voice. The microphone 92 is provided for collecting voice uttered by the people on board the vehicle V. For example, the microphone 92 is disposed on the dashboard, a roof console, or the like so as to easily collect voice uttered by the user U who drives the vehicle V and the person seated in the passenger seat 7b. A plurality of microphones 92 may be provided in the interior of the vehicle V. For example, a microphone for collecting voice uttered by the people seated in the rear right seat 7c, rear center seat 7d, and rear left seat 7e may be provided at a position different from the dashboard.

The doors 2-5 are provided with door switches 80-83 for detecting opening and closing of the doors, respectively. A tail gate 6 is also provided with a door switch 84 for detecting opening and closing of the tail gate 6. Furthermore, a power switch 54 and a shift switch 55a for detecting a shift position of a shift lever 55 are provided near the driver's seat 7a. The vehicle V includes an accelerator pedal sensor 50a for detecting pedaling force on an accelerator pedal 50, a brake pedal sensor 51a for detecting pedaling force on a brake pedal 51, and a side-brake switch 52a for detecting on/off of a side-brake pedal 52.

The vehicle V further includes door lock mechanisms 100-104 for locking the doors 2-5 and tail gate 6 respectively, a speed sensor 120 for detecting travel speed of the vehicle V, a communication unit 130 (receiver/transmitter), and a navigation device 140. The communication unit 130 includes an antenna, and communicates with the user terminal 150, portable key 160, service management server 400, and the like. The navigation device 140 includes a GPS (Global Positioning System) sensor (not shown) and map data, and executes route guidance to a destination and the like based on a position of the vehicle V detected by the GPS sensor and the map data. The communication unit 130 may form part of the information providing device 1.

### [3. Configuration of Information Providing Device]

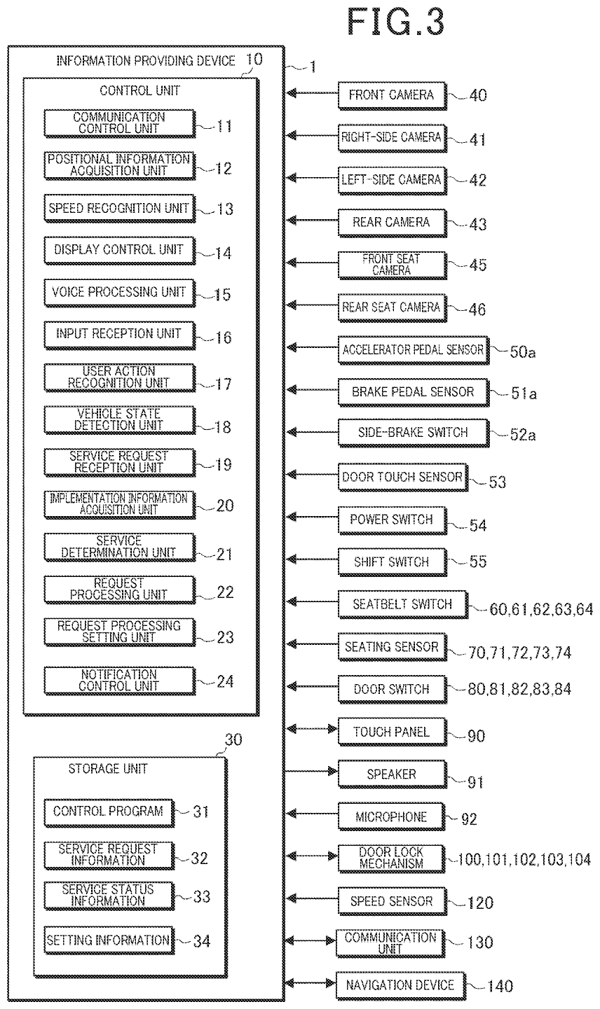

A configuration of the information providing device 1 will be described with reference to FIG. 3. The information providing device 1 includes a control unit 10 for controlling each unit of the information providing device 1 and a storage unit 30 (recording medium) for storing a program and data. The control unit 10 executes a control program 31 stored in the storage unit 30 by a processor such as a CPU (Central Processing Unit) or microcomputer, and implements various functions of the information providing device 1. FIG. 3 shows, as functional units configured by the control unit 10, a communication control unit 11, a positional information acquisition unit 12, a speed recognition unit 13, a display control unit 14, a voice processing unit 15, an input reception unit 16, a user action recognition unit 17, a vehicle state detection unit 18, a service request reception unit 19, an implementation information acquisition unit 20, a service determination unit 21, a request processing unit 22, a request processing setting unit 23, and a notification control unit 24. These functional units are implemented by collaboration of software and hardware, for example, by the processor executing the program. The control unit 10 may be equipped with hardware corresponding to those functional units. The control unit 10 may include an interface circuit (not shown).

Images around the vehicle V taken with the front camera 40, right-side camera 41, left-side camera 42, and rear camera 43 are input to the information providing device 1. Images in the interior of the vehicle V taken with the front seat camera 45 and rear seat camera 46 are also input to the information providing device 1. A voice signal of voice collected by the microphone 92 is input to the information providing device 1 from the microphone 92. The microphone 92 may form part of the information providing device 1.

Detection signals of the accelerator pedal sensor 50a, brake pedal sensor 51a, side-brake switch 52a, door touch sensor 53, power switch 54, shift switch 55a, seatbelt switches 60-64, seating sensors 70-74, and door switches 80-84, and lock detection signals of the doors 2-5 and tail gate 6 by the door lock sensors (not shown) provided in the door lock mechanisms 100-104 are input to the information providing device 1.

A touch position detection signal of the touch panel 90, a speed detection signal of the speed sensor 120, and information on the current position (latitude and longitude) of the vehicle V detected by the navigation device 140 are input to the information providing device 1.

Screen display of the touch panel 90 and sound (such as voice guidance and chime sound) output from the speaker 91 are controlled by a control signal output from the information providing device 1.

The storage unit 30 is composed of a semiconductor memory device or magnetic recording device, and has stored therein a program and data in a non-volatile manner. The storage unit 30 has stored therein service request information 32, service status information 33, and setting information 34 in addition to the control program 31.

The communication control unit 11 controls the communication unit 130 to communicate with the user terminal 150, portable key 160, service management server 400, and the like. The communication control unit 11 stores information received from the service management server 400 in the storage unit 30 as needed. When the communication control unit 11 communicates through the communication network 500, the communication control unit 11 may use the user terminal 150 as a communication unit. The communication control unit 11 corresponds to an example of the communication unit together with the communication unit 130.

The positional information acquisition unit 12 acquires the information on the current position of the vehicle V from the navigation device 140.

The speed recognition unit 13 recognizes the speed of the vehicle V based on the speed detection signal of the speed sensor 120.

The display control unit 14 outputs a display control signal to the touch panel 90 based on data of a screen to be displayed on the touch panel 90, and causes the touch panel 90 to display the screen including characters or images.

The voice processing unit 15 outputs a voice signal to the speaker 91, and outputs voice from the speaker 91. The voice processing unit 15 converts the voice signal collected by the microphone 92 into digital voice data and processes the digital voice data.

The input reception unit 16 receives an input by the user U based on a touch position detection signal input from the touch panel 90. The input reception unit 16 identifies contents operated by the user U by using the data of the screen which the display control unit 14 causes the touch panel 90 to display.

The user action recognition unit 17 recognizes an action of the user U based on the captured images around the vehicle V taken with the front camera 40, right-side camera 41, left-side camera 42, and rear camera 43, the captured images in the interior of the vehicle V taken with the front seat camera 45 and rear seat camera 46, the detection signals of the accelerator pedal sensor 50a, brake pedal sensor 51a, side-brake switch 52a, door touch sensor 53, power switch 54, shift switch 55a, seatbelt switches 60-64, seating sensors 70-74, and door switches 80-84, the lock detection signals of the doors 2-5 and tail gate 6 by the door lock sensors (not shown) provided in the door lock mechanisms 100-104, and the like.

The vehicle state detection unit 18 detects a state of the vehicle V based on the detection signals of the accelerator pedal sensor 50a, brake pedal sensor 51a, side-brake switch 52a, door touch sensor 53, power switch 54, shift switch 55a, and door switches 80-84, the lock detection signals of the doors 2-5 and tail gate 6 by the door lock sensors (not shown) provided in the door lock mechanisms 100-104, the speed of the vehicle V recognized by the speed recognition unit 13, and the like. The vehicle state detection unit 18 corresponds to an example of a moving state detection unit.

The service request reception unit 19 receives a request for product purchase or service provision in response to a touch operation of an order button displayed on the touch panel 90. The communication control unit 11 controls communication via the communication unit 130, and transmits purchase information to the service management server 400 via the communication unit 130 when the request for product purchase or service provision is received by the service request reception unit 19. When the purchase information is transmitted to the service management server 400 regarding the service for which the request is received, the service request reception unit 19 generates the service request information 32 for the service and stores it in the storage unit 30. The service request information 32 is information indicating a service for which a request by the user U is received.

The implementation information acquisition unit 20 acquires the implementation information indicating the implementation status of the service from the service management server 400. The communication control unit 11 controls communication via the communication unit 130, transmits a request generated by the implementation information acquisition unit 20 to the service management server 400, and receives the implementation information transmitted by the service management server 400 in response to the request.

The service determination unit 21 determines the implementation status of the service for the vehicle V based on the implementation information acquired by the implementation information acquisition unit 20. For example, the service determination unit 21 determines based on the implementation information whether the service has been completed or not regarding the service for which the request is received by the service request reception unit 19. The service determination unit 21 generates the service status information 33 including a determination result determined based on the implementation information and stores it in the storage unit.

The request processing unit 22 transmits request information to the service management server 400. The communication control unit 11 transmits the request information generated by the request processing unit 22 to the service management server 400 by the communication unit 130.

The request information generated and transmitted by the request processing unit 22 includes first request information and second request information, and these are collectively referred to as request information. The first request information is request information requesting suspension of the service. The suspension of the service means to suspend the service by creating a state where the service is temporarily not provided for the vehicle V. In the case where the implementation of the service is not completed, when the service is suspended, the service business operator 450 does not implement the service and waits. When a service cancellation request is made during the wait, the service business operator 450 cancels the service. The second request information is request information requesting cancellation of the service. The cancellation of the service means to cancel the request received by the service request reception unit 19. In the case where the implementation of the service is not completed, when the service is cancelled, the service business operator 450 does not implement the service.

As described later, when the vehicle V starts moving in a state where it is determined that the service is not completed, the request processing setting unit 23 sets an operation of automatically transmitting the request information by the request processing unit 22. For example, the request processing setting unit 23 sets whether the request information to be automatically transmitted by the request processing unit 22 is either the first request information or second request information. The request processing setting unit 23 generates the setting information 34 including setting contents and stores it in the storage unit 30. The request processing setting unit 23 corresponds to an example of a setting unit.

The notification control unit 24 notifies the user U. The notification control unit 24 generates, for example, a notification screen to be displayed on the touch panel 90. The display control unit 14 causes the touch panel 90 to display the screen generated by the notification control unit 24. For example, the notification control unit 24 generates notification voice data. The voice processing unit 15 outputs voice from the speaker 91 based on the voice data generated by the notification control unit 24. The notification control unit 24 forms a notification unit together with the touch panel 90 and/or speaker 91.

### [4. Outline of Operation of Information Providing System]

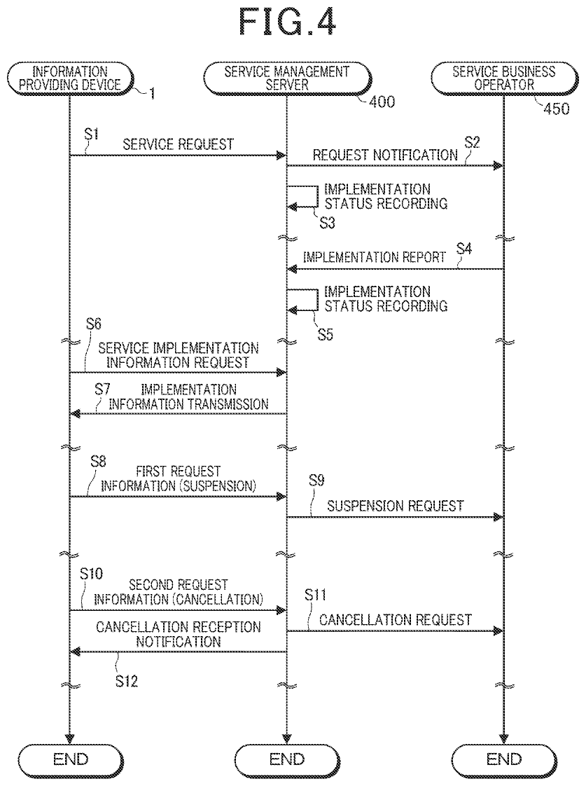

FIG. 4 is a sequence diagram illustrating an outline of operation of the information providing system 200, and shows operation of each of the information providing device 1 and service management server 400. It also shows an action taken by the service business operator 450 in relation to the operation of the service management server 400.

The information providing device 1 transmits the request of the service received by the service request reception unit 19 according to the operation of the user U to the service management server 400 (step S1). The service management server 400 receives the request of the information providing device 1, and notifies the service business operator 450 of the request based on the received request (step S2). Consequently, the service business operator 450 is scheduled to execute the service requested by the user U. The service management server 400 associates and records the service requested by the information providing device 1 with the implementation status of the service (step S3).

When the service business operator 450 implements the service, the service business operator 450 reports the implementation of the service to the service management server 400 (step S4). The service management server 400 records completion of the implementation of the service (step S5).

The information providing device 1 can request the service management server 400 to provide the implementation information indicating the implementation status of the service any time including before and after the service business operator 450 implements the service. When the information providing device 1 requests the implementation information (step S6), the service management server 400 transmits the implementation information to the information providing device 1 (step S7).

The information providing device 1 can transmit the first request information requesting suspension of the service to the service management server 400 before the service is implemented, in other words, when the implementation of the service has not been completed. When the information providing device 1 transmits the first request information (step S8), the service management server 400 transmits a request to suspend the service to the service business operator 450 (step S9).

When the implementation of the service has not been completed, the information providing device 1 can transmit the second request information requesting cancellation of the service to the service management server 400. When the information providing device 1 transmits the second request information (step S10), the service management server 400 transmits a request to cancel the service to the service business operator 450 (step S11). The service management server 400 notifies the information providing device 1 of reception of the cancellation of the service (step S12).

### [5. Operation of Information Providing Device]

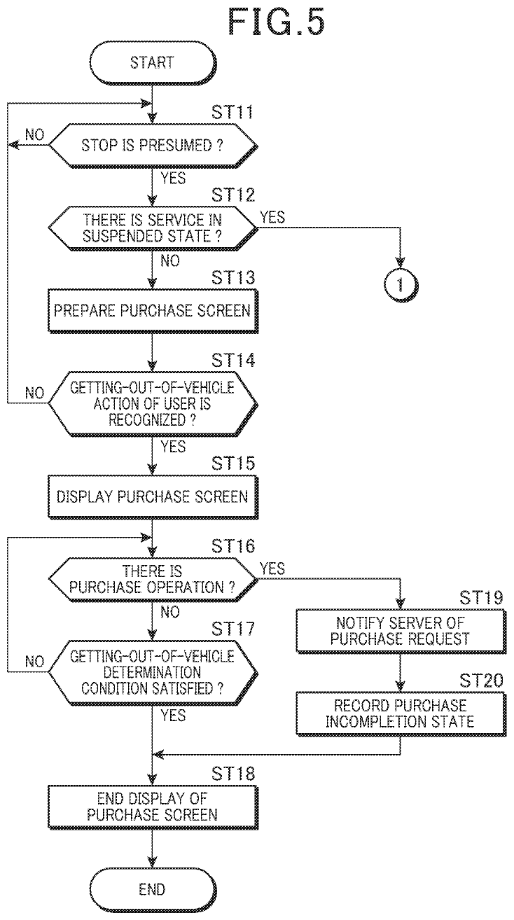

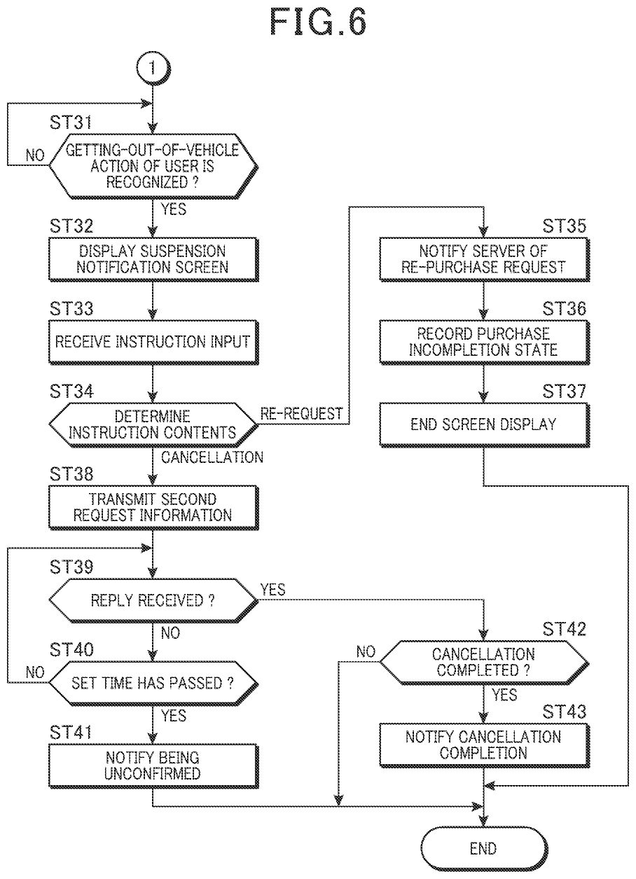

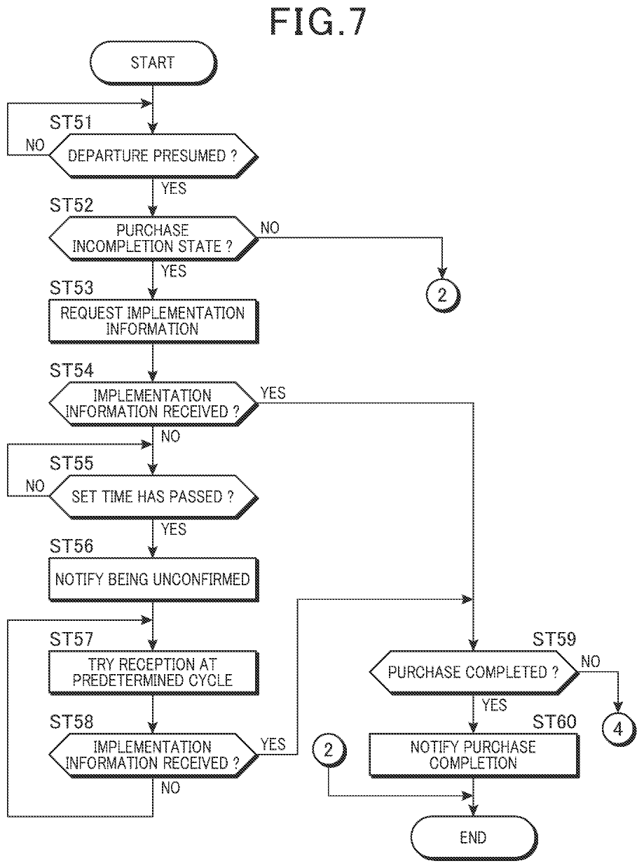

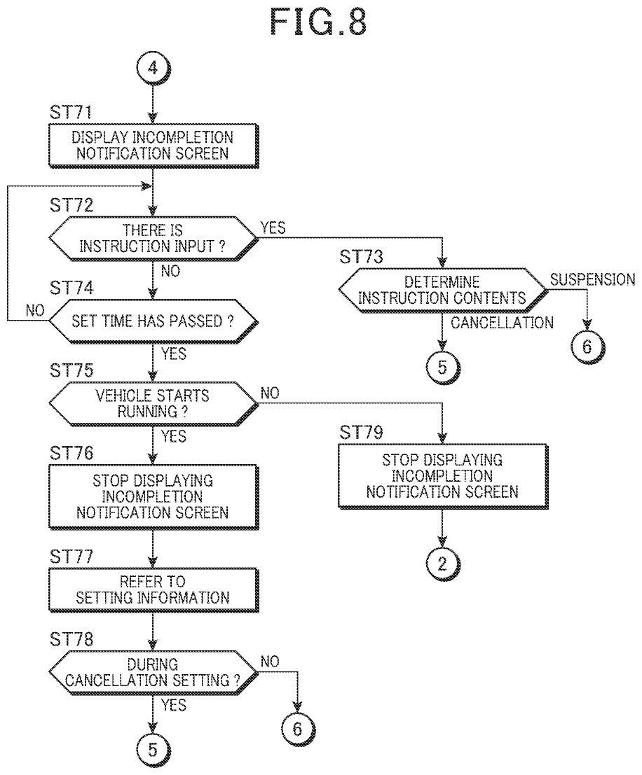

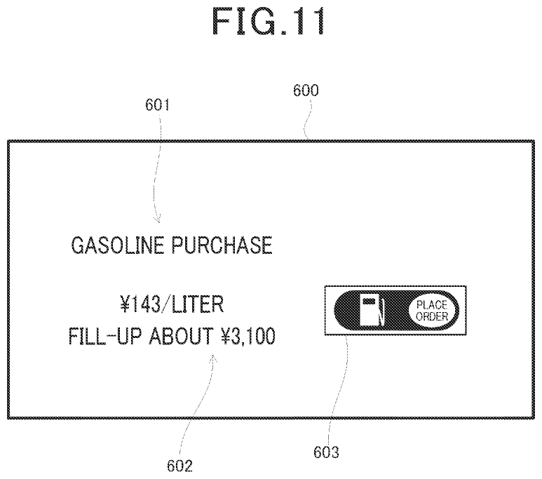

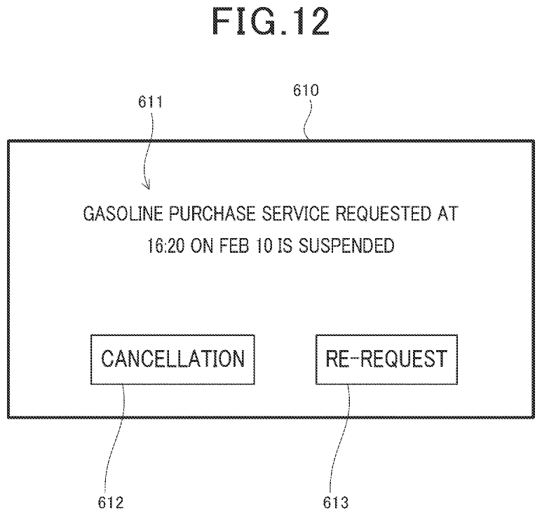

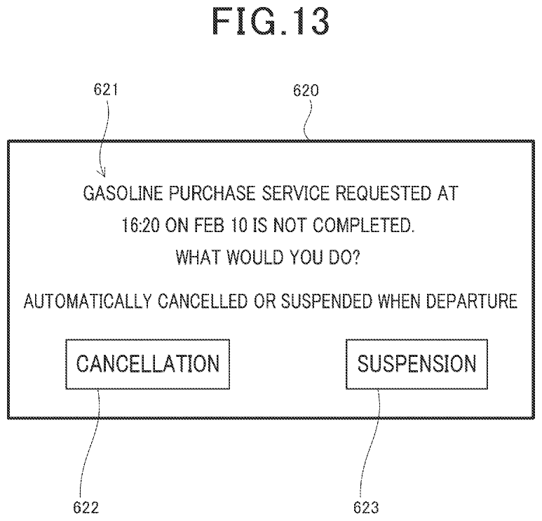

FIGS. 5 and 6 are flowcharts illustrating operation of the information providing device 1, and show operation when it is presumed that the vehicle V will stop. FIGS. 7, 8, 9, and 10 are flowcharts illustrating operation of the information providing device 1, and show operation when it is presumed that the vehicle V will start moving. FIG. 11 is a diagram illustrating an example of a purchase screen 600 displayed by control of the information providing device 1, FIG. 12 is a diagram illustrating an example of a suspension notification screen 610, and FIG. 13 is a diagram illustrating an example of an incompletion notification screen 620. The operation of the information providing device 1 will be described below according to the flowcharts of FIGS. 5-10 with reference to FIGS. 11-13.

The operation shown in FIGS. 5 and 6 is executed while the vehicle V is running.

The vehicle state detection unit 18 determines whether the vehicle V is in a stop preparation state where it is presumed that the vehicle V will stop (step ST11). The stop preparation state is a state where, for example, the speed of the vehicle V is 10 km/h or less, and the vehicle state detection unit 18 makes a determination based on the speed recognized by the speed recognition unit 13. In addition, the stop preparation state may be a state where a specific operation is applied to the accelerator pedal 50, brake pedal 51, and side-brake pedal 52. In this case, the vehicle state detection unit 18 makes the determination in step ST11 based on the signals input from the accelerator pedal sensor 50a, brake pedal sensor 51a, side-brake switch 52a, and the like. The vehicle state detection unit 18 may make the determination in step ST11 based on the captured images around the vehicle V taken with the front camera 40, right-side camera 41, left-side camera 42, and rear camera 43, the captured images in the interior of the vehicle V taken with the front seat camera 45 and rear seat camera 46, the detection signals of the door touch sensor 53, power switch 54, shift switch 55a, seatbelt switches 60-64, seating sensors 70-74, and door switches 80-84, the lock detection signals of the doors 2-5 and tail gate 6 by the door lock sensors (not shown) provided in the door lock mechanisms 100-104, and the like.

When the vehicle V is not determined to be in the stop preparation state (step ST11; NO), the vehicle state detection unit 18 waits while repeatedly making the determination in step ST11 at a predetermined cycle. When the vehicle V is determined to be in the stop preparation state (step ST11; YES), the service determination unit 21 refers to the service status information 33 and determines whether there is a service which is in the suspended state due to the first request information (step ST12).

When there is no service in the suspended state (step ST12; NO), the service request reception unit 19 prepares data of the purchase screen 600 for receiving a request for the service (step ST13).

The purchase screen 600 is a screen that guides the user U to use the service by characters or images, and includes a contents display portion 601 that shows contents of the service which can be purchased and a price display portion 602 as shown in FIG. 11. The user U can refer to the contents display portion 601 and price display portion 602, and consider whether to purchase the service. The purchase screen 600 has an order button 603 for instructing purchase of the service. When the user U touches the order button 603, the service request reception unit 19 receives a purchase request for the service.

The user action recognition unit 17 recognizes an action of the user U, and determines whether there is a getting-out-of-vehicle action from which it is presumed that the user U will get out of the vehicle V (step ST14). The user action recognition unit 17 recognizes, for example, an off operation of the power switch 54 as the getting-out-of-vehicle action. The user action recognition unit 17 may recognize the getting-out-of-vehicle action from the captured image taken with the front seat camera 45. The user action recognition unit 17 may recognize that the user U has taken the getting-out-of-vehicle action when the detection signal of the door switch 80 of the right front door 2 becomes off (door open state), or when the detection signal of the seatbelt switch 60 of the driver's seat 7a is off (state where the seatbelt is unfastened).

When the user action recognition unit 17 has not recognized the getting-out-of-vehicle action (step ST14; NO), operation of the control unit 10 returns to step ST11.

When the getting-out-of-vehicle action is recognized (step ST14; YES), the display control unit 14 causes the touch panel 90 to display the purchase screen 600 generated by the service request reception unit 19 (step ST15).

The service request reception unit 19 determines whether there is an operation of the user U to the order button 603 on the purchase screen 600 (step ST16).

When the order button 603 is not operated (step ST16; NO), the user action recognition unit 17 determines whether a getting-out-of-vehicle determination condition for determining that the user U has got out of the vehicle V is satisfied (step ST17). In the embodiment, it is set, as the getting-out-of-vehicle determination condition, to recognize that the detection signal of the door switch 80 of the right front door 2 is switched from on (closed state detection)→off (open state detection)→on (closed state detection). Other than the determination by the door switch 80, or in addition to the determination by the door switch 80, the user action recognition unit 17 may recognize that the user U has got out of the vehicle V by using a detection signal of a lock switch of the door lock mechanism 100 of the right front door 2, the captured image taken with the front seat camera 45, the captured image taken with the rear seat camera 46, the captured image taken with the right-side camera 41, or the like.

When the getting-out-of-vehicle determination condition is satisfied (step ST17; YES), the service request reception unit 19 ends the display of the purchase screen 600 by a function of the display control unit 14 (step ST18) and ends the process.

When the getting-out-of-vehicle determination condition is not satisfied (step ST17; NO), the operation of the control unit 10 returns to step ST16.

When the service request reception unit 19 detects the operation of the order button 603 (step ST16; YES), the service request reception unit 19 transmits the purchase request for the service to the service management server 400 (step ST19). The operation in step ST19 corresponds to step S1 in FIG. 4.

The service request reception unit 19 generates the service request information 32 including information such as service name, type, and date and time, information indicating the purchase request for the service is made, and information indicating the purchase request for the service has not been completed, stores it in the storage unit 30 (step ST20), and then proceeds to step ST18.

On the other hand, when the service determination unit 21 determines that there is a suspended service (step ST12; YES), the user action recognition unit 17 determines whether there is a getting-out-of-vehicle action of the user U (step ST31). In step ST31, the determination is made in the same manner as in step ST14. When the user action recognition unit 17 has not recognized the getting-out-of-vehicle action (step ST31; NO), the control unit 10 waits until the getting-out-of-vehicle action is recognized.

When the getting-out-of-vehicle action of the user U is recognized (step ST31; YES), the notification control unit 24 notifies that the service is suspended (step; ST32). In the embodiment, the notification control unit 24 causes the touch panel 90 to display the suspension notification screen 610 related to the suspended service. The notification control unit 24 generates data of the suspension notification screen 610, and the display control unit 14 causes the touch panel 90 to display the suspension notification screen 610.

As shown in FIG. 12, the suspension notification screen 610 includes a notification display unit 611 for displaying information for identifying the suspended service, a message informing that the service is suspended, and the like.

The suspension notification screen 610 includes a cancellation instruction button 612 for the user U to instruct cancellation of the service and a re-request instruction button 613 for instructing re-request for the service.

The request processing unit 22 receives an operation of the user U to the suspension notification screen 610 (step ST33). That is, the request processing unit 22 receives an instruction input as to whether to cancel or re-request the suspended service.

In step ST34, when an operation of the re-request instruction button 613 is received, the service request reception unit 19 notifies the service management server 400 of the purchase request (step ST35). The notification in step ST35 is to notify resumption of the suspended service based on the first request information (step S8 in FIG. 1).

The service request reception unit 19 creates or updates the service request information 32 regarding the re-requested service, and stores it in the storage unit 30 (step ST36). The notification control unit 24 ends the display of the suspension notification screen 610 by a function of the display control unit 14 (step ST37), and ends the process.

In step ST34, when an operation of the cancellation instruction button 612 is received, the request processing unit 22 transmits the second request information requesting cancellation of the service (step ST38). The request processing unit 22 determines whether a reply to the second request information is received from the service management server 400 (step ST39). When the reply is not received (step ST39; NO), the request processing unit 22 determines whether a preset time has passed since the transmission of the second request information (step ST40). When the set time has not passed (step ST40; NO), the request processing unit 22 returns to step ST39. When the set time has passed (step ST40; YES), the notification control unit 24 notifies that a determination whether the cancellation of the service has been completed is not completed (step ST41), and ends the process. In step ST41, for example, a screen that indicates in letters that the determination whether the cancellation of the service has been completed is not completed is displayed on the touch panel 90. In addition, notification by voice may be performed in step ST41.

When the request processing unit 22 receives the reply from the service management server 400 (step ST39; YES), the request processing unit 22 determines based on the received reply whether a process involved in the cancellation has been completed (step ST42). When it is not determined that the process involved in the cancellation has been completed (step ST42; NO), the control unit 10 ends the process. When it is determined that the process involved in the cancellation has been completed (step ST42; YES), the notification control unit 24 notifies that the cancellation of the service has been completed (step ST43), and ends the process. In step ST43, for example, a screen that indicates in letters that the cancellation of the service has been completed is displayed on the touch panel 90. In addition, notification by voice may be performed in step ST43.

The operation shown in FIGS. 7-10 is executed while the vehicle V is stopped.

The vehicle state detection unit 18 determines whether the vehicle V is in a specific state from which it is presumed that the vehicle V will depart (start moving) (step ST51). The specific state includes, for example, a state where the power switch 54 of the vehicle V is operated and an ignition is turned on. A state where operation to the shift lever 55, accelerator pedal 50, brake pedal 51, or side-brake pedal 52 is applied may be set as the specific state. The vehicle state detection unit 18 may detect the specific state when the user U and other passengers get in from a state where the user U is not in the vehicle V. In this case, the vehicle state detection unit 18 recognizes that the user U and the other passengers get in the vehicle V based on the captured images around the vehicle V taken with the front camera 40, right-side camera 41, left-side camera 42, and rear camera 43, and the captured images in the interior of the vehicle V taken with the front seat camera 45 and rear seat camera 46. Furthermore, in this case, the vehicle state detection unit 18 may recognize that the user U and the other passengers get in the vehicle V based on the detection signals of the seatbelt switches 60-64 and seating sensors 70-74. The vehicle state detection unit 18 may detect the specific state when the door lock is released while the door lock mechanisms 100-104 are locked. In this case, the vehicle state detection unit 18 detects the specific state based on the lock detection signals of the doors 2-5 and tail gate 6 by the door lock sensors (not shown) and the like. The vehicle state detection unit 18 may detect the specific state after a predetermined time has passed since the doors 2-5 were opened and closed. The vehicle state detection unit 18 may detect the specific state when an operation of the user U to the doors is detected by the detection signal of the door touch sensor 53 and door switches 80-84.

When the specific state is not detected (step ST51; NO), the vehicle state detection unit 18 waits until the specific state is detected. When the specific state is detected (step ST51; YES), the service determination unit 21 refers to the service request information 32, and determines whether there is a service for which purchase is not completed (step ST52). When the service determination unit 21 determines that there is no any service for which purchase is not completed (step ST52; NO), the service determination unit 21 ends the process.

When the service determination unit 21 determines that there is a service for which purchase is not completed (step ST52; YES), the service determination unit 21 requests the implementation information from the service management server 400 (step ST53). After the request for the implementation information is transmitted to the service management server 400 by the display control unit 14, the service determination unit 21 determines whether the implementation information is received (step ST54). When the implementation information is not received (step ST54; NO), the service determination unit 21 determines whether a preset time has passed since the transmission of the request (step ST55). When the set time has not passed (step ST55; NO), the service determination unit 21 returns to step ST54. When the set time has passed (step ST55; YES), the notification control unit 24 notifies that the implementation of the service is unconfirmed (step ST56). In step 56, for example, a screen that indicates in letters that the implementation of the service is unconfirmed is displayed on the touch panel 90. In addition, in step ST56, notification may be performed by voice.

The service determination unit 21 causes the communication control unit 11 to try receiving the implementation information at a predetermined cycle (step ST57), and determines whether the implementation information is received (step ST58). While the implementation information is not received (step ST58; NO), the service determination unit 21 returns to step ST57. When the implementation information is received (step ST58; YES), the service determination unit 21 determines based on the implementation information whether purchase is completed by the implementation of the service (step ST59). In addition, when the service determination unit 21 determines in step ST54 that the implementation information is received, the service determination unit 21 proceeds to step ST59.

Regarding the service which the information providing device 1 requested from the service management server 400 in steps ST19 and ST35, the purchase is completed when the service is implemented. Therefore, when it is determined based on the implementation information that the implementation of the service is completed, the purchase is completed. The service determination unit 21 determines that the purchase is completed (step ST59; YES) when the implementation information indicates completion of the implementation of the service. In this case, the notification control unit 24 notifies purchase completion (step ST60), and ends the process. In step ST60, for example, a screen that indicates in letters that the purchase is confirmed is displayed on the touch panel 90, or notification by voice is performed.

When the service determination unit 21 determines that the purchase of the service has not been completed (step ST59; NO), the notification control unit 24 notifies incompletion of the service (step ST71). In the embodiment, the notification control unit 24 generates data of the incompletion notification screen 620, and the display control unit 14 causes the touch panel 90 to display the incompletion notification screen 620.

As shown in FIG. 13, the incompletion notification screen 620 includes a notification display portion 621 that displays information for identifying the service for which the purchase is not completed, a message notifying that the service is not completed, and the like. The incompletion notification screen 620 also includes a cancellation instruction button 622 for the user U to instruct cancellation of the service and a suspension instruction button 623 for instructing suspension of the service. Also, the incompletion notification screen 620 may include a notification portion 624 for notifying that the service is automatically cancelled or suspended when the vehicle V departs.

The request processing unit 22 receives an operation of the user U to the incompletion notification screen 620. That is, the request processing unit 22 receives an instruction input as to whether to cancel or suspend the suspended service. The request processing unit 22 determines whether there is an instruction input by an operation of the cancellation instruction button 622 or suspension instruction button 623 (step ST72).

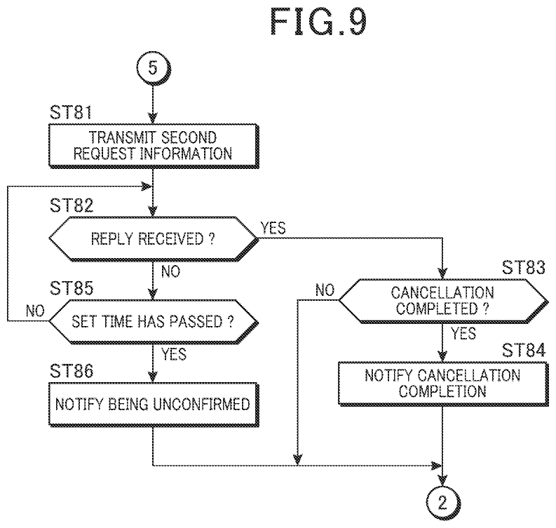

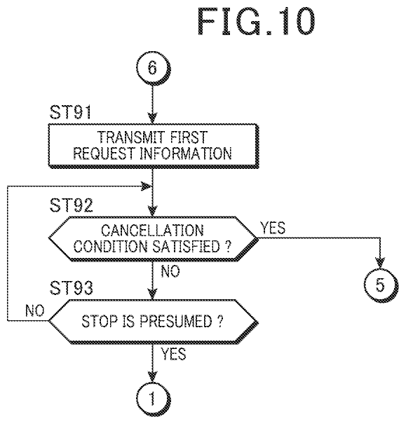

When there is an instruction input to the incompletion notification screen 620 (step ST72; YES), the request processing unit 22 determines contents of the instruction input (step ST73). When the contents of the instruction input are cancellation of the service, the request processing unit 22 proceeds to step ST81 (FIG. 9) described later. When the contents of the instruction input are suspension of the service, the request processing unit 22 proceeds to step ST91 (FIG. 10) described later.

When there is no instruction input to the incompletion notification screen 620 (step ST72; NO), the request processing unit 22 determines whether a preset time has passed since the display of the incompletion notification screen 620 (step ST74). When the set time has not passed (step ST74; NO), the request processing unit 22 returns to step ST72. When the set time has passed (step ST74; YES), the vehicle state detection unit 18 determines whether the vehicle V has started running (moving) (step ST75). For example, when the speed of the vehicle V recognized by the speed recognition unit 13 is faster than 0 km/h, the vehicle state detection unit 18 determines that the vehicle V has started running. In addition, for example, when a shift position is switched from a position for stop (for example, a P range or an N range) to a position for driving (for example, a D range) by operation of the shift lever 55, the vehicle state detection unit 18 may determine that the vehicle V has started running. For example, when an operation to the accelerator pedal 50 is detected by the accelerator pedal sensor 50a after release of the side brake is detected by the side-brake switch 52a, the vehicle state detection unit 18 may determine that the vehicle V has started running.

When it is determined that the vehicle V has started running (step ST75; YES), the notification control unit 24 stops displaying the incompletion notification screen 620 (step ST76). The request processing unit 22 refers to the setting information 34 (step ST77), and determines whether cancellation setting has been made (step ST78). The setting information 34 is information indicating contents set by the request processing setting unit 23, and information related to setting of how to process the service when the vehicle V starts moving in a state where the service is not completed. In particular, either cancellation setting to cancel the service or suspension setting for suspending the service is set in the setting information 34.

When the request processing unit 22 determines that the cancellation setting has been made based on the setting information 34 (step ST78; YES), the request processing unit 22 proceeds to step ST81 described later.

The request processing unit 22 determines that the cancellation setting has not been made (step ST78; NO) when the suspension setting is made in the setting information 34 or there is no setting in the setting information 34. In this case, the request processing unit 22 proceeds to step ST91.

When it is determined that the vehicle V has not started running (step ST75; YES), the notification control unit 24 stops displaying the incompletion notification screen 620 (step ST79), and ends the process. Note that the control unit 10 may return to step ST72 without stopping displaying the incompletion notification screen 620 in step ST79.

In step ST81, the request processing unit 22 transmits the second request information to the service management server 400. The request processing unit 22 determines whether a reply of the service management server 400 to the second request information is received (step ST82).

When the reply is received (step ST82; YES), the request processing unit 22 determines whether the process involved in cancellation is completed based on the reply of the service management server 400 (step ST83). When the reply of the service management server 400 has contents indicating reception of cancellation, the request processing unit 22 determines that the process of cancellation is completed (step ST83; YES). In this case, the notification control unit 24 notifies that the process involved in cancellation is completed by display of the touch panel 90 or voice (step ST84) and ends the process.

When the reply is not received (step ST82; NO) the request processing unit 22 determines whether a preset time has passed since the transmission of the second request information (step ST85). When the set time has not passed (step ST85; NO), the service determination unit 21 returns to step ST82. When the set time has passed (step ST85; YES), the notification control unit 24 notifies that a determination whether the cancellation process is completed is unconfirmed by display of the touch panel 90 or voice (step ST86), and ends the process.

In step ST91, the request processing unit 22 transmits the first request information to the service management server 400. Then, the request processing unit 22 determines whether a cancellation condition is satisfied (step ST92). The cancellation condition may be that the vehicle V is away from the parking point Pa by a predetermined distance or more, distance travelled by the vehicle V from the parking point Pa is a predetermined distance or more, the position of the vehicle V is continuously away from the parking point Pa for a predetermined time or more, and the like. The request processing unit 22 can make the determination in step ST92 based on, for example, the speed of the vehicle V recognized by the speed recognition unit 13 and the position of the vehicle V detected by the navigation device 140.

When the cancellation condition is satisfied (step ST92; YES), the request processing unit 22 proceeds to step ST81, and transmits the second request information.

When the cancellation condition is not satisfied (step ST92; NO), the vehicle state detection unit 18 determines whether the vehicle V is in the stop preparation state (step ST93). The stop preparation state determined in step ST92 may be, for example, the same as in step ST11. In addition, the state may be closer to a stop than step ST11. In particular, in step ST93, the vehicle state detection unit 18 may set a state where the speed of the vehicle V is 5 km/h or less as the stop preparation state. When it is determined that the vehicle V is not in the stop preparation state (step ST93; NO), the operation of the control unit 10 returns to step ST92. When it is determined that the vehicle V is in the stop preparation state (step ST93; YES), the control unit 10 proceeds to step ST31.

### [6. Other Embodiments]

In the above embodiment, the four-wheeled vehicle V is exemplified as the movable body of the present invention, but the present invention is applicable to various passenger movable bodies such as a two-wheeled vehicle, a flying body, and a ship.

In the above-embodiment, the notification control unit 24 is described as one that notifies with any one or more means of display by the touch panel 90 and voice output by the speaker 91. The notification control unit 24 may execute notification by using the user terminal 150 or navigation device 140.

The information providing device 1 is not limited to one fixedly installed on the vehicle V, and the functions of the information providing device 1 described in the above embodiment may be implemented by a portable terminal device. The portable terminal device is, for example, the user terminal 150, but may be a device such as another mobile phone, smartphone, tablet computer, and laptop. For example, the portable terminal device acquires information input to the control unit 10 from each unit mounted on the vehicle V by wireless communication means, and thereby the portable terminal device can perform functions of recognizing the state of the user U in the vehicle V by the user action recognition unit 17, and detecting the state of the vehicle V by the vehicle state detection unit 18. In this case, the portable terminal device can perform functions of the service request reception unit 19, implementation information acquisition unit 20, service determination unit 21, request processing unit 22, request processing setting unit 23, and notification control unit 24. Regarding functions of the communication control unit 11, positional information acquisition unit 12, speed recognition unit 13, display control unit 14, and voice processing unit 15, part or all of them can be also implemented by the portable terminal device according to a configuration of hardware.

The above embodiment exemplifies the configuration in which the information providing device 1 communicates with the service management server 400 by using the communication unit 130, but the information providing device 1 may include a built-in wireless communication device.

FIG. 3 is a schematic diagram showing the functional configuration of the information providing device 1 by classifying according to main processing contents, in order to facilitate understanding of the invention of the present application, and configurations of the information providing device 1 may be configured according to other respective classifications. Processing of each component may be executed by one hardware unit, or may be executed by a plurality of hardware units. Processing of each component shown in FIGS. 5-10 may be executed by one program or may be executed by a plurality of programs.

### [Configurations Supported by Above Embodiments]

The above embodiments are specific examples of the following configurations.

(Article 1) An information providing device comprising a processor, wherein the processor functions as: a communication control unit for communicating with a server; an implementation information acquisition unit for acquiring, by the communication control unit, implementation information indicating implementation status of a service which is provided at a stop position of a movable body; a moving state detection unit for detecting a moving state of the movable body; and a notification control unit for notifying the implementation status of the service based on the implementation information when the moving state detection unit detects a specific state from which it is presumed that the movable body will start moving.

According to the information providing device of Article 1, the user enjoying the service is notified of the implementation status of the service when it is presumed that the movable body will start moving. Thereby, the user of the service can be informed of the implementation status of the service at appropriate timing. Therefore, for example, when it becomes necessary to move the movable body after the user requests the service, the user can be notified of the implementation status of the service. As a result, the user can appropriately determine, for example, whether to enjoy the service or whether to move the movable body, and the convenience of the user can be improved.

(Article 2) The information providing device according to Article 1, wherein the processor functions as: a service determination unit for determining whether implementation of the service is completed based on the implementation information; and a request processing unit for causing the communication control unit to transmit request information requesting suspension or cancellation of the implementation of the service when the service determination unit determines that the implementation of the service is not completed, wherein the processor causes the request information to be transmitted, by a function of the request processing unit, in any of a period from the detection of the specific state to the start of moving of the movable body, when the movable body starts moving, and within a predetermined time after the movable body starts moving.

According to the information providing device of Article 2, since the suspension or cancellation of the service is transmitted to the server when the movable body starts moving, the service is appropriately suspended or cancelled without an intentional operation by the user. Therefore, it is possible to avoid default of the service and a state where the service cannot be executed, and it is possible to improve the convenience of both user and service provider.

(Article 3) The information providing device according to Article 2, wherein the processor notifies, by a function of the notification control unit, that the implementation of the service is suspended or cancelled when the service determination unit determines that the implementation of the service is not completed.

According to the information providing device of Article 3, the user is informed that the implementation of the service will be suspended or cancelled and can appropriately determine whether to move the movable body or the like, and the convenience of the user can be improved.

(Article 4) The information providing device according to Article 2 or 3, wherein the processor, by a function of the request processing unit, causes the communication control unit to transmit first request information requesting suspension of the implementation of the service when the moving state detection unit detects start of moving of the movable body, and causes the communication control unit to transmit second request information requesting cancellation of the implementation of the service when a specific condition is satisfied after the movable body starts moving.

According to the information providing device of Article 4, when the movable body moves in a state where the implementation of the service is not completed, the service can be suspended, and furthermore, when provision of the service is difficult or the like, the service can be cancelled. This enables the user to enjoy the service by suspending the service so that the service can be resumed, for example, regarding a small-scale movement for which there is no need to cancel the service, and can avoid default of the service and the state where the service cannot be executed by cancelling when provision of the service is difficult or the like. In this way, since a frequency when the service is cancelled is reduced and suspension and cancellation are done as needed, the convenience of both user and service provider can be improved.

(Article 5) The information providing device according to Article 2 or 3, wherein the processor functions as a setting unit for setting whether to transmit either first request information requesting suspension of the implementation of the service or second request information requesting cancellation of the implementation of the service, by the communication control unit, wherein: the processor causes the communication control unit to transmit request information requesting suspension or cancellation of the implementation of the service according to setting of the setting unit by a function of the request processing unit when the service determination unit determines that the implementation of the service is not completed; and the notification control unit notifies the service for which suspension is requested when the moving state detection unit detects stop of the movable body after request information requesting suspension of the implementation of the service is transmitted by the communication control unit.

According to the information providing device of Article 5, it is possible to notify the user that the service is suspended. Therefore, even if the user forgets the suspension of the service, the user can appropriately judge the suspended service.

(Article 6) An information providing system comprising a server and an information providing device for communicating with the server, wherein the information providing device includes a processor, wherein the processor functions as: a communication control unit for communicating with the server; an implementation information acquisition unit for acquiring, by the communication control unit, implementation information indicating implementation status of a service which is provided at a stop position of a movable body; a moving state detection unit for detecting a moving state of the movable body; and a notification control unit for notifying the implementation status of the service based on the implementation information when the moving state detection unit detects a specific state from which it is presumed that the movable body will start moving, wherein the server transmits the implementation information indicating the implementation status of the service to the information providing device.

According to the information providing system of Article 6, regarding the service provided by the information providing device and the server, when it is presumed that the movable body will start moving, the user is notified of the implementation status of the service. Thereby, the user of the service can be informed of the implementation status of the service at appropriate timing, and the user can appropriately determine, for example, whether to enjoy the service or whether to move the movable body.

(Article 7) A control method of an information providing device executed by a processor of the information providing device that provides information on implementation of a service, the control method of the information providing device comprising: acquiring implementation information indicating implementation status of the service whose service provision location is a stop position of a movable body from a server; detecting a moving state of the movable body; and notifying the implementation status of the service based on the implementation information when a specific state from which it is presumed that the movable body will start moving is detected.

According to the control method of the information providing device of Article 7, the user enjoying the service is notified of the implementation status of the service when it is presumed that the movable body will start moving. Thereby, the user of the service can be informed of the implementation status of the service at appropriate timing, and the user can appropriately determine, for example, whether to enjoy the service or whether to move the movable body.

(Article 8) A recording medium non-temporary, computer-readable, and having recorded a control program of an information providing device executed by a processor of the information providing device that communicates with a server, wherein the control program causes the processor to: acquire implementation information indicating implementation status of the service whose service provision location is a stop position of a movable body from the server; detect a moving state of the movable body; and notify the implementation status of the service based on the implementation information when a specific state from which it is presumed that the movable body will start moving is detected.

According to the program of Article 8, the user enjoying the service is notified of the implementation status of the service when it is presumed that the movable body will start moving. Thereby, the user of the service can be informed of the implementation status of the service at appropriate timing, and the user can appropriately determine, for example, whether to enjoy the service or whether to move the movable body.

### REFERENCE SIGNS LIST

1 . . . Information providing device
10 . . . Control unit
11 . . . Communication control unit (communication unit)
12 . . . Positional information acquisition unit
13 . . . Speed recognition unit
15 . . . Voice processing unit
16 . . . Input reception unit
17 . . . User action recognition unit
18 . . . Vehicle state detection unit (moving state detection unit)
19 . . . Service request processing unit
20 . . . Implementation information acquisition unit
21 . . . Service determination unit
22 . . . Request processing unit
23 . . . Request processing setting unit (setting unit)
24 . . . Notification control unit (notification unit)
30 . . . Storage unit
31 . . . Control program
32 . . . Service request information
33 . . . Service status information
34 . . . Setting information
90 . . . Touch panel (notification unit)
91 . . . Speaker (notification unit)
92 . . . Microphone
120 . . . Speed sensor
130 . . . Communication unit (communication unit)
140 . . . Navigation device
150 . . . User terminal
200 . . . Information providing system
400 . . . Service management server (server)
600 . . . Purchase screen
610 . . . Suspension notification screen
620 . . . Completion notification screen
U . . . User
V . . . Vehicle (movable body)

What is claimed is:

1. An information providing device comprising a processor,
wherein the processor functions as:
a communication control unit for communicating with a server;
an implementation information acquisition unit for acquiring, by the communication control unit, implementation information indicating implementation status of a service which is provided at a stop position of a movable body;
a moving state detection unit for detecting a moving state of the movable body; and
a notification control unit for notifying the implementation status of the service based on the implementation information when the moving state detection unit detects a specific state from which it is presumed that the movable body will start moving.

2. The information providing device according to claim 1,
wherein the processor functions as:
a service determination unit for determining whether implementation of the service is completed based on the implementation information; and
a request processing unit for causing the communication control unit to transmit request information requesting suspension or cancellation of the implementation of the service when the service determination unit determines that the implementation of the service is not completed,
wherein the processor
causes the request information to be transmitted, by a function of the request processing unit, in any of a period from the detection of the specific state to the start of moving of the movable body, when the movable body starts moving, and within a predetermined time after the movable body starts moving.

3. The information providing device according to claim 2,
wherein the processor
notifies, by a function of the notification control unit, that the implementation of the service is suspended or cancelled when the service determination unit determines that the implementation of the service is not completed.

4. The information providing device according to claim 2,
wherein the processor, by a function of the request processing unit,
causes the communication control unit to transmit first request information requesting suspension of the implementation of the service when the moving state detection unit detects start of moving of the movable body, and causes the communication control unit to transmit second request information requesting cancellation of the implementation of the service when a specific condition is satisfied after the movable body starts moving.

5. The information providing device according to claim 2,
wherein the processor functions as
a setting unit for setting whether to transmit either first request information requesting suspension of the implementation of the service or second request information requesting cancellation of the implementation of the service, by the communication control unit, wherein:
the processor
causes the communication control unit to transmit request information requesting suspension or cancellation of the implementation of the service according to setting of the setting unit by a function of the request processing unit when the service determination unit determines that the implementation of the service is not completed; and
the notification control unit notifies the service for which suspension is requested when the moving state detection unit detects stop of the movable body after request information requesting suspension of the implementation of the service is transmitted by the communication control unit.

6. An information providing system comprising a server and an information providing device for communicating with the server,
wherein the information providing device
includes a processor,
wherein the processor functions as:
a communication control unit for communicating with the server;
an implementation information acquisition unit for acquiring, by the communication control unit, implementation information indicating implementation status of a service which is provided at a stop position of a movable body;
a moving state detection unit for detecting a moving state of the movable body; and
a notification control unit for notifying the implementation status of the service based on the implementation information when the moving state detection unit detects a specific state from which it is presumed that the movable body will start moving,
wherein, by a server-side processor, the server transmits the implementation information indicating the implementation status of the service to the information providing device.

7. A control method of an information providing device executed by a processor of the information providing device that provides information on implementation of a service, the control method of the information providing device comprising:
acquiring implementation information indicating implementation status of the service whose service provision location is a stop position of a movable body from a server;
detecting a moving state of the movable body; and
notifying the implementation status of the service based on the implementation information when a specific state from which it is presumed that the movable body will start moving is detected.
